(19) United States
(12) Patent Application Publication
(10) Pub. No.: US 2006/0187831 A1
(43) Pub. Date: Aug. 24, 2006

(54) Remote monitoring and remote control arrangement for an independent target location

(76) Inventor: Jarmo Justen, Kirkkonummi (FI)

Correspondence Address: YOUNG & THOMPSON, 745 SOUTH 23RD STREET, 2ND FLOOR, ARLINGTON, VA, 22202, US

(21) Appl. No.: 11/269,554

(22) Filed: Nov. 9, 2005

(30) Foreign Application Priority Data
Nov. 9, 2004 (FI) 20041443

(51) Int. Cl. H04L 12/26; H04L 1/00

(52) U.S. Cl. 370/229

(57) ABSTRACT

An arrangement is provided for facilitating remote monitoring and control of an independent target location. Physical level devices (106, 107, 108, 109, 110, 111, 112, 211) are adapted to at least acquire information at the target location. A transceiver (511) is adapted to exchange information with a remote central system. Between the physical level devices (106, 107, 108, 109, 110, 111, 112, 211) and the transceiver (511) there is a two-tier hierarchy of system elements. The two-tier hierarchy includes a multitude of nodes (221) and at least one controller module (231, 231′). Of these nodes (221) are connected to the physical level devices (106, 107, 108, 109, 110, 111, 112, 211), and the controller module (231, 231′) is connected to the nodes (221) and to the transceiver (511).

The invention concerns generally the technology of remote monitoring and control. Especially the invention concerns the task of setting up, maintaining and operating a remote monitoring and remote control arrangement within a relatively isolated, independent location where the monitoring and control functionalities must be highly automated.

As an example of an independent target location requiring remote monitoring and control we may consider the base station site of a cellular radio system. The actual base station electronics typically include built-in telemetric operation and maintenance systems of their own, which are outside the scope of the present consideration. More interesting from the point of view of the present invention is the site itself, which usually comprises a closed space adapted to house the electronic units as well as the immediate cable connections to and from said closed space (for example from and to an antenna), a potential antenna mast, and a power source adapted to supply the local electronic units with the necessary operating voltages.

A variety of factors may require monitoring and control at a base station site. The open/closed state and movements of a door, a hatch or similar access control means to said closed space should be monitored in order to properly exclude unauthorised access and to give a warning if an attempt of unauthorised access is suspected to be in progress. The internal temperature and humidity of the closed space should be at least monitored and preferably also controlled in order to at least detect and preferably also react to the occurrence of extreme conditions that might harm the operation of the electronics. The condition of cables should be monitored in order to get an early warning of a potential cable breakage. The uninterrupted delivery of electric energy from the power source to the local electronic units should be carefully monitored in order to enable commencing proper action in a blackout situation. If the power source includes back-up batteries meant to deliver operating power during a blackout, the internal condition and capability of the batteries to fulfil their emergency task should be monitored.

Known remote monitoring and control arrangements have usually been customised systems, including a collection of sensors and actuators connected to the input and output ports of a centralised control unit. FIG. 1 illustrates schematically a prior art remote monitoring and control arrangement, which here is shown as installed at a base station site of a cellular radio system but which concerning by its structure could as well be e.g. the electronic remote monitoring and control arrangement of a modem automated home. The base station electronics unit 101 and its power source 102 are housed in a small building or container 103. An antenna cable 104 connects the base station electronics unit 101 to an antenna (not shown). A door 105 provides access to the inside of the container 103 for authorised personnel. A door position sensor 106 is provided for monitoring the open/closed state of the door 105. For circulating air in the container 103 there are two fans 107 and 108. A temperature sensor 109 and a humidity sensor 110 exist for monitoring environmental conditions inside the container 103. A surveillance camera 111 monitors the environment. A cable condition sensor 112 measures the condition of the antenna cable 104.

A customised central unit 120 is adapted to collect information from the various sensors in the remote monitoring and control arrangement of FIG. 1 and to give commands to actuators, if any (for example to control the operation of the fans 107 and 108, or to turn the camera 111). The customised central unit 120 comprises a long-distance communications module, for example a GSM data phone module, in order to communicate measurement information to a remote user and to receive control commands from said remote user. The long-distance communications module is not separately shown in FIG. 1. If the monitored and controlled target location is a base station site, the long-distance communications module could be replaced with a suitable connection to the base station electronics unit 101, which would be adapted to handle connections to and from the customised central unit 120 as if they were ordinary cellular (data) phone calls.

The disadvantages of the prior art remote monitoring and control arrangement of FIG. 1 are mainly related to its nature as a custom-built system. Since the remote monitoring and control needs of different target locations are seldom quite identical, either a number of differently operating central units must be designed for use in different applications, or the central unit must be designed to have a large variety of inherent capabilities, of which only a part will be used for any particular application. Both possibilities are likely to increase the manufacturing cost of the system. A technician the task of whom is to install and service the prior art remote monitoring and control arrangements must have a high level of specialised training and skill. The backpayment time, i.e. the time it takes for a prior art remote monitoring and control arrangement to produce financial gain for the worth of its manufacturing and assembling cost, is long. Another disadvantage is the relatively large amount of cables and wiring that are needed due to the star-like configuration, in which the central unit acts as a center point from which the sensor and actuator wiring extends to all directions.

An objective of the present invention is to present a remote monitoring and control arrangement that is versatile, reliable and cost effective. An additional objective of the present invention is to present a remote monitoring and control arrangement that is simple to assemble and customise for any specific application. A yet another objective of the invention is to present a remote monitoring and control arrangement that only needs a relative simple wiring.

The objectives of the invention are achieved with an architecture where the connections between a controller module and sensors, switches and other physical level devices in the remote monitoring and control arrangement go through intelligent, yet simple “nodes”. Preferably the nodes are linked to each other and to the controller module through a simple serial bus, on which a multiple access protocol is used to separate transmissions related to different nodes from each other.

A remote monitoring and control arrangement according to the invention is characterized by the features recited in the characterising part of the independent claim directed to an arrangement.

According to an aspect of the invention, the-component devices that constitute a remote monitoring and control arrangement can be divided into four categories according to the amount of their inherent intelligence and programmability. At the lowest level there are sensors. Indicators, switches, actuators, movement detectors, measurement heads and other physical level devices that need to have neither intelligence nor programmability, At the next higher level there are the so-called nodes A node is a simple, small-sized electronic device built around an integrated circuit, which is widely adaptable to interface with a large variety of physical level devices. The node also implements an ultimately simple and standardised communication interface, through which a large number of nodes can be linked with each other. A node contains a certain degree of intelligence, but is not programmable bar a limited number of simple control features, such as a programmable address that identifies within the multitude of nodes, and a status word. As a basic assumption there is one node per each physical level device; the node is a kind of standardised representation of the physical level device towards the higher level categories of the remote monitoring and control arrangement.

On the third level there are one or more controller modules. Each controller module comprises a microcontroller and a communication interface towards the nodes, through which the microcontroller can exchange information with a large number of nodes, and which most advantageously also acts as a power supply through which the nodes receive the electric power required in their operation. The controller module is programmable, so that it can adapt itself to any required configuration of nodes and physical level devices coupled to the nodes, and arrange the communication at the standardised communication interface that couples the nodes to each other and to the controller module. There may be dozens, or even hundreds of nodes coupled to a controller module.

From the controller module there is a data interface, for example an RS-232-, RS-485- or Ethernet connection or a long-distance communications connection such as a packet-switched cellular radio connection, to the fourth hierarchical level, which comprises at least one server, portal, workstation or other computer adapted for use in viewing, analysing, processing and storing collected information as well as controlling the operation of the remote monitoring and control arrangement.

The physical level devices are naturally located at their required locations in the environment where the remote monitoring and control arrangement is arranged to operate. Nodes are most advantageously located very near to the physical level devices, because of the typical one-to-one correspondence between nodes and physical level devices. Since a typical site to be monitored and controlled may comprise something like 20-30 nodes, and since a single controller module may handle something like up to 200 nodes, there is seldom required more than one controller module at each remotely monitored and controlled location. If two or more controller modules are needed, they can be linked together through a serial bus. Ethernet or other suitable local connection. The rate at which information needs to be transferred between the nodes and the controllers, or between the controllers of a single remote monitoring and control arrangement, is typically very slow compared to the information transmission rates encountered in data networks between computers, which allows the connections to be implemented with very simple and cost effective way.

The novel features which are considered as characteristic of the invention are set forth in particular in the appended claims, The invention itself, however, both as to its construction and its method of operation, together with additional objects and advantages thereof, will be best understood from the following description of specific embodiments when read in connection with the accompanying drawings.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

FIG. 1 illustrates a prior art remote monitoring and control arrangement,

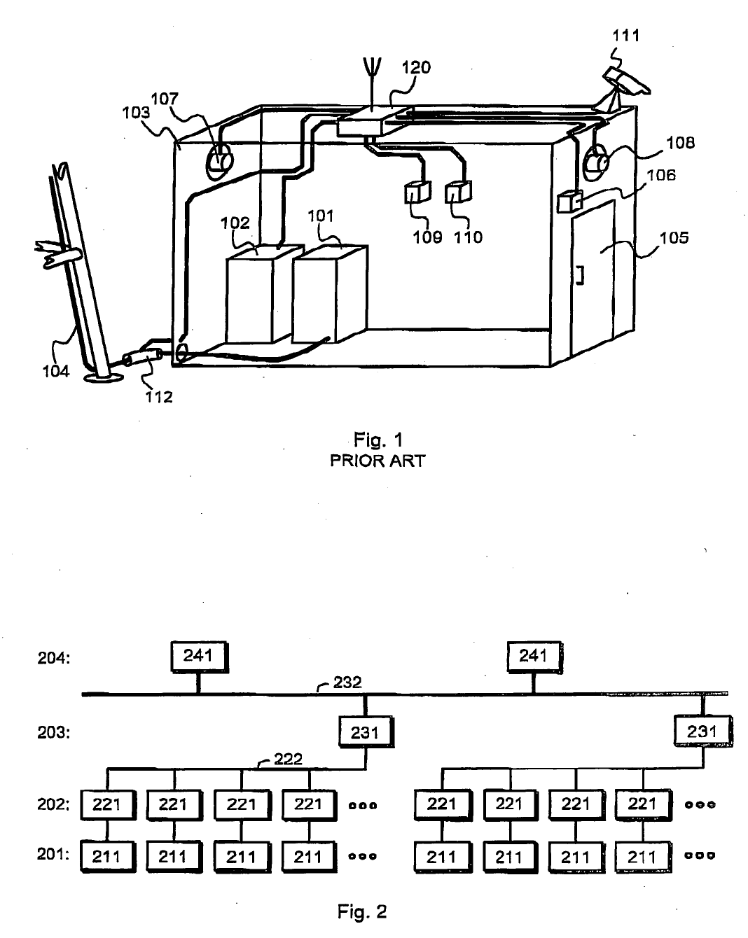

FIG. 2 illustrates the hierarchy of devices in a remote monitoring and control arrangement according to an embodiment of the invention,

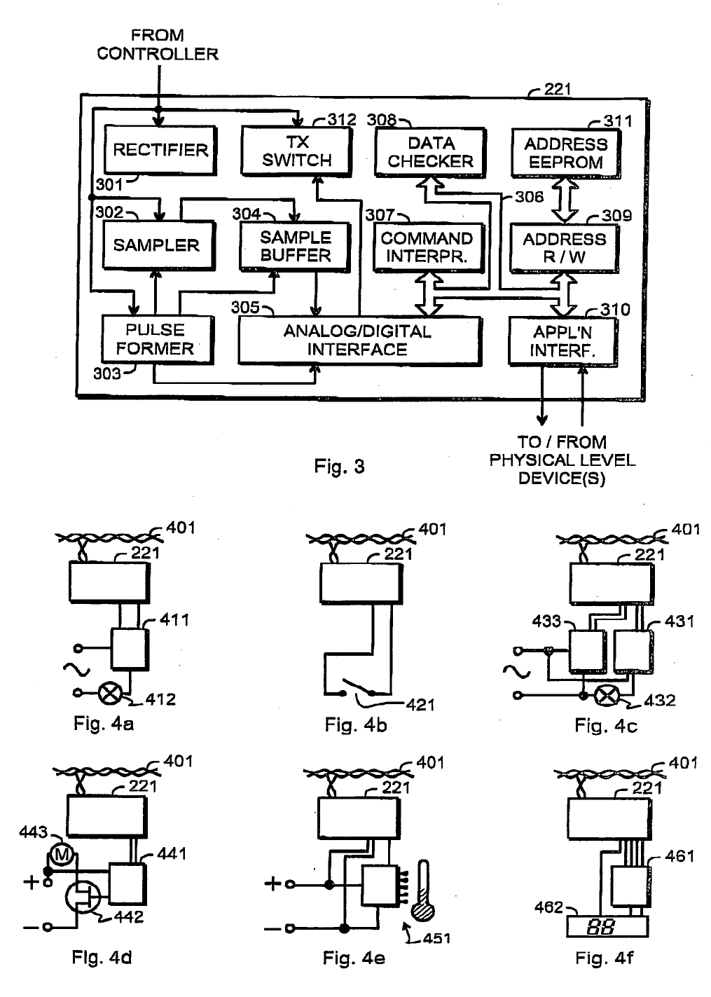

FIG. 3 illustrates an exemplary node,

FIGS. 4a to 4f illustrate exemplary ways of coupling a node with a physical level device,

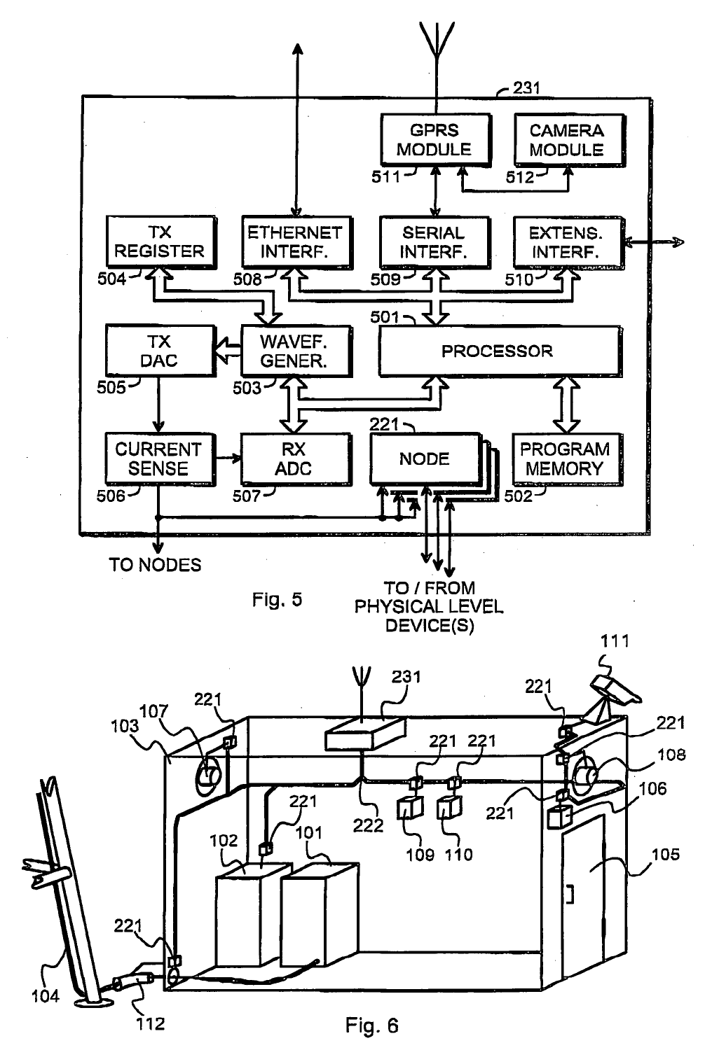

FIG. 5 illustrates an exemplary controller module,

FIG. 6 illustrates a remote monitoring and control arrangement according to an embodiment of the invention,

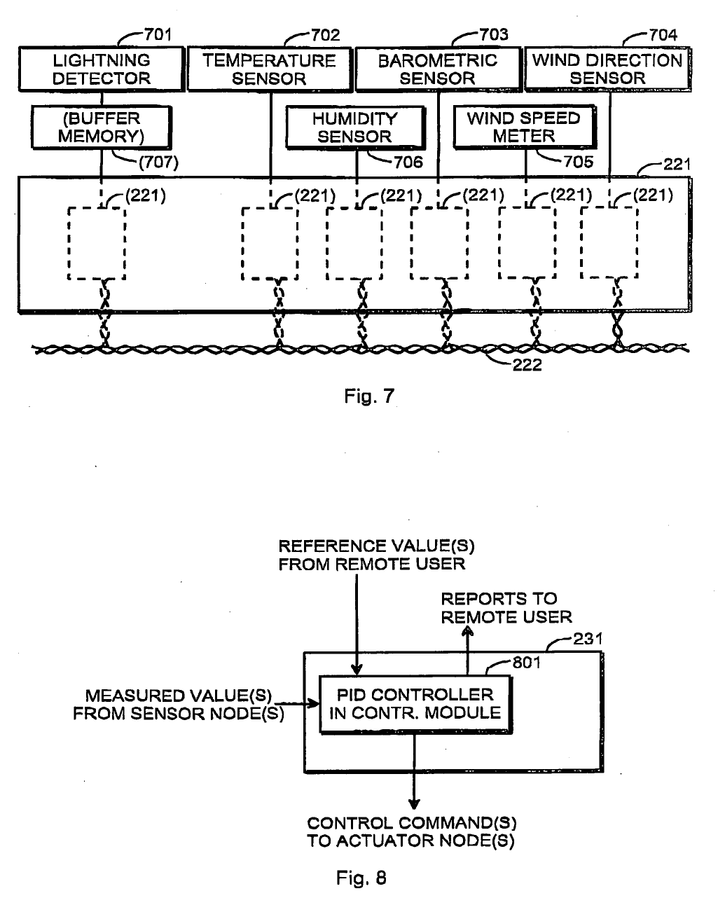

FIG. 7 illustrates the composition of a weather station used in a remote monitoring and control arrangement according to an embodiment of the invention,

FIG. 8 illustrates the principle of PID control in a remote monitoring and control arrangement according to an embodiment of the invention,

FIG. 2 shows how the devices of a remote monitoring and control arrangement according to an embodiment of the invention may be classified into hierarchical levels 201, 202, 203 and 204. At the lowest level 201 there are physical devices 211. Including but not being limited to switches, indicators, measurement heads, actuators and the like. None of these needs to comprise any intelligence or programmability. At the next higher level 202 there are nodes 221, preferably with one to one correspondence with the physical devices 211 so that there is a dedicated node 221 for each physical device 211. The amount of intelligence and programmability comprised in each node 221 is very limited and will be discussed in more detail later in this description. The connection between each physical device 211 and the corresponding node 221 depends on the nature and functionality of the physical device 211 in question.

At the third level 203 from the bottom there are controller modules 231, which comprise much more intelligence and programmability than the nodes 221. A large number of nodes 221 may be connected to a single controller module 231, so that preferably there should be only one controller module per each independent target location to be monitored and/or controlled. In order to keep the amount of required wiring at a reasonable level, the connection arrangement 222 that connects the nodes 221 to the controller module 231 should be kept as simple as possible. In an advantageous embodiment of the invention the connection arrangement 222 consists simply of a twisted pair, which runs from node to node and also to the controller module 231. In order to realise communication and power delivery through a single twisted pair, using the connection arrangement 222 must involve a multiple access scheme such as TDMA (time division multiple access). The invention does not exclude heavier alternatives for the connection arrangement 222 than a twisted pair with a multiple access scheme, but multifold wires would quickly accumulate to essentially equal the complexity of the wiring in the prior art solution of FIG. 1.

From the controller modules 231 on the third level 203 there is a network connection 232 to computer devices 241 on the fourth and highest level 204. Very few limitations apply to the number and/or nature of the computer devices 241. Typically these include mass storage devices, workstations for information management, gateways to other networks and the like. The network connection 232 may involve even very large distance connections, such as internet, intranet or VPN (Virtual Private Network) connections to and from computers that can be located anywhere in the world. Common telecommunications systems, like PSTN (Public Switched Telecommunications Network) or cellular radio systems may be used as parts of the network connection 232, for which purpose the controller modules 231 may be equipped with specific hardware, like GSM (Global System for Mobile telecommunications) or UMTS (Universal Mobile Telecommunications System) data telephone modules, GPRS (General Packet Radio Service) modules or the like.

FIG. 3 illustrates schematically the internal structure of an exemplary node 221, which here is essentially similar to a circuit element designated as “connection unit” in a patent publication U.S. Pat. No. 5,920,253. Said patent publication also describes a TDMA arrangement based on a sinusoidal carrier waveform, in which half-waves of one polarity are used to distribute power and half-waves of the other polarity are allocated to the connected devices according to a certain timetable for use in transferring data. In the following we assume that a single twisted pair and TDMA are used to connect the node 221 to other nodes and to a controller module (not shown in FIG. 3). The first functional block to connect to said twisted pair in the node 221 is a rectifier 301, which is adapted to rectify a part of an oscillating signal provided through said twisted pair to provide a supply voltage for the other functional blocks within the node 221. The delivery of electric power from the rectifier 301 to the other parts of the node 221 is not separately shown in FIG. 3 for graphical clarity.

Also connected to the twisted pair are a sampler 302 and a pulse former 303. Of these, the pulse former 303 is adapted to produce a train of clock pulses locked to the oscillating waveform that comes in through the twisted pair, and the sampler 302 is adapted to sample said oscillating waveform appropriately in order to decode the information content embedded therein. The samples are taken, through a sample buffer 304, to an analog/digital interface 305 internal to the node 221. On the digital side there is an internal bus 306 that couples said analog/digital interface 305 with a command interpreter 307, a data checker 308, an address read and write interface 309 and an application interface 310. An address EEPROM (Electrically Erasable Programmable Read Only Memory) 311 is adapted to store a unique bit address of the node 221. In use, a node should only react to incoming commands associated with its own address, with the possible addition that some addresses may be defined as “group” or “broadcast” addresses, so that a command associated with a broadcast address is to be observed by all nodes of a group or all nodes in a system. Physical level devices are to be coupled to the node through the application interface 310.

if order to also realise transmission of information in the uplink direction between the node 221 and a controller module the node 221 must include some kind of transmission means. In the exemplary embodiment of FIG. 3 these consist of a transmission switch 312 which is adapted to controllably short circuit the twisted pair connection (preferably through a suitable series resistance) during certain time intervals that have been allocated to the node in question. A controller module will notice a changed resistance (or more generally a changed impedance) value of the twisted pair, which it can then interprete as a certain bit value transmitted by that node for which that time interval was allocated.

The node 221 is most advantageously built so that a large majority of all functionalities shown in FIG. 3 are implemented in an integrated circuit. In order to make the node a standard, yet versatile building block that allows using it for many different purposes in a remote monitoring and control arrangement, it is advantageous to provide the application interface 310 with a number of built-In input and output functions such as digital to analog converting output, phase-angle controlling output, toggle output, pulse width modulation output, bit stream output, analog to digital converting input and switch input. The command interpreter 307 must be correspondingly adapted to recognise commands that cause such input and output functions to be implemented in practice.

FIGS. 4a to 4f illustrate combining nodes with various physical level devices, simultaneously illustrating the versatility that can be achieved in remote monitoring and control arrangements by utilising the invention. In each of these cases a node 221 is shown to have a connection to a twisted pair 401, which acts as the connection arrangement 222 shown in a more abstract way in FIG. 2. FIG. 4a illustrates a controllable toggle switch arrangement, in which a node 221 ia coupled to drive a solid-state relay 411, which in turn switches on or off a load 412 coupled to an external AC voltage supply. FIG. 4b illustrates an input switch arrangement, in which a node 221 is coupled to detect the conduction state of a switch 421. On/off type outputs like the one of FIG. 4a as well as on/off type inputs like the one of FIG. 4b may involve the use of optocouplers in order to achieve galvanic isolation between the node proper and the currents and voltages that are present in the monitored or controlled physical device.

FIG. 4c illustrates a phase-angle controller arrangement, in which a node 221 is coupled to drive an external triac driver 431, which in turn acts as a “dimmer” that controls steplessly the amount of electric power delivered from an external AC voltage supply to a load 432. The node 221 locks to the frequency and phase of the external AC voltage supply through an optocoupler 433. FIG. 4d illustrates a PWM (Pulse Width Modulation) controller arrangement, in which a node 221 is coupled to deliver PWM switching pulses through an optocoupler 441 to a solid-state switch 442, which thus repeatedly chops the DC electric power coupled to an inductive load 443.

FIG. 4e illustrates an analog input arrangement, in which a node 221 is coupled to receive an analog voltage value coming from a measurement device 451. An internal analog to digital converter of the node 221 is adapted to convert the received analog voltage value into digital form, which the node 221 can communicate through the twisted pair 401 to another node and/or to a controller module (not shown in FIG. 4e). A temperature sensor is shown as an example of a measurement device in FIG. 4e, but the same principle is applied in a straightforward manner with other kinds of measurement devices, like quantitatively measuring infrared sensors (qualitative on/off type infrared sensors compare most readily with the switch 421 of FIG. 4b), humidity sensors, wind speed and wind direction sensors weight or tension sensors, power sensors, current sensors, voltage sensors and the like.

FIG. 4f illustrates a data output arrangement, in which a node 221 delivers a digital value it has received through the twisted pair 401 to an auxiliary indicator device, which here consists of a driver circuit 461 and the indicator proper 462, which here is a 7-segment character display. If the power consumption of the auxiliary digitally controlled device (here the auxiliary indicator device) is smaller than an output power limit of the node 221, it is possible to deliver operating power from the node to the digitally controlled device as well as control signals.

FIG. 5 illustrates schematically an exemplary controller module 231, which here is essentially similar to what has been described as “control unit” in the patent publication U.S. Pat. No. 5,920,253 already mentioned above. A functional core of the controller module 231 is a microprocessor 501 adapted to read and execute a program stored in a program memory 502. At the disposal of the microprocessor 501 there is a controllable waveform generator 503, which is adapted to generate a waveform that is most advantageously a sinusoidal basic waveform in which certain half-waves have been modified, in accordance with information read from a transmission register 504, in order to represent desired bit values. An interface to the twisted pair to nodes comprises a transmission digital to analog converter 606, which feeds the generated waveforms in analog form to the twisted pair. An arrangement of a current sensing block 506 and a reception analog to digital converter 507 provide means for detecting how the nodes transmit information by drawing various amounts of current during their allocated time intervals. Means for connecting the controller module 231 to devices on the higher hierarchical level comprise in FIG. 4 an Ethernet interface 508, a general-purpose serial interface 509 as well as an extension interface 510, which also allows connecting the controller module to an external user interface for e.g. on-the-spot configuration changes. A GPRS module 511 is shown connected to the serial interface 509 for establishing a long-distance connection to devices of the highest, fourth hierarchical level. If a GPRS module has a built-in processor interface, it can also be coupled directly to the microprocessor 501.

A camera module 512 appears here as connected directly to the GPRS module 511. This is a design choice resulting from the fact that at the time of writing this description, the general interest in internet-connected real time cameras has brought to the market advantageous “netcam” type camera modules that have been built for this kind of connections. A controller module that supports camera applications might have also a camera module connected or integrated to the microprocessor 512, or the camera might be located behind a node just like any other physical level device.

FIG. 5 shows also the possibility of integrating some nodes 221 into a common structural entity (e.g. onto the same circuit board) with the controller module 231. Concerning the functional architecture of the whole system, as well as the hierarchical arrangement of the system elements, it is still advantageous to connect the integrated node(s) 221 to the output of the current sensing block 506 as if they were “ordinary” nodes located further away from the controller module 231 along a twisted pair. The most advantageous use of the intagrated node(s) 221 is to associate them with physical level devices located very close to the controller module 231, or even to use them as interfaces to functional entitles within the controller module 231 itself. For example, an integrated node 221 might be used as means for performing a “hard reset” (power off/power on) to the GPRS module 511, the camera module 512 or some other functional entity, or—together with an appropriate physical level device—as means for monitoring the power consumption, internal temperature or some other operational parameter of the controller module 231.

FIG. 6 illustrates the application of the principle described above to building a remote monitoring and control arrangement at a site similar to that discussed earlier in association with FIG. 1. The core of the remote monitoring and control arrangement is a controller module 231. Close to each physical level device there is a corresponding node 221. The connection arrangement 222 that connects the nodes together and to the controller module 231 is most advantageously a single twisted pair, which can be branched and extended essentially freely, most advantageously even without having to care about polarity, since the nodes 221 are not sensitive to the polarity in the switched pair they are coupled to. Operation commands travel from the controller module 231 through the connection arrangement 222 to the nodes 221. Each node has an address, which is typically unique, although group addresses can be additionally or alternatively used. From an address field in an operation command each node recognizes, whether the command is pertinent to it. A node that receives a pertinent command acts accordingly, for example by returning some requested information obtained from the physical level device attached to the node, or causing the physical level device to perform some predefined action. Measurement results, status reports and other information gathered by the nodes from the physical level devices travel through the same connection arrangement 222 to the controller module 231.

As illustrative examples we will describe some specific kinds of nodes or node groups. A first example is a node or node group, which together with associated physical level hardware constitutes a miniature weather station. Previously we noted how a base station site of a cellular radio system is a typical isolated, independent target location at which remote monitoring and control should be performed. We should additionally note that the totality of base station sites in a cellular radio systems constitutes a relatively regular network of observation points with extensive geographical coverage. This network of observation points can be used for collecting accurate and extensive real time weather information. If only there are enough base station sites equipped with both the necessary observation instruments and the capability of conveying observation results to a central computer for statistical compilation and processing.

FIG. 7 illustrates schematically an arrangement in which a weather station can be associated either with one node or a group of nodes. The physical level devices that constitute the observation and measurement instrumentation of the weather station comprise a lightning detector 701, an outside temperature sensor 702, a barometric sensor 703, a wind direction sensor 704, a wind speed meter 705 and a humidity sensor 706. An optional buffer memory 707 has been shown associated with the lightning detector 701, meaning that the numer of lightning detected by the detector 701 is accumulated and readable at the buffer memory 707. According to a first possibility there is a single weather station node 221, shown in continuous line in FIG. 7, which is equipped with six inputs on the physical devices side and thereby adapted to read the outputs of the physical level devices 701 to 706 and to communicate the obtained readings to a controller module (not shown in FIG. 7) through the connection arrangement 222. According to a second possibility there might be a separate node 221, shown in dashed line in FIG. 7, for each physical level device, each node being coupled independently to the connection arrangement 222.

FIG. 7 could even be undestood according to a third alternative in which more than one node are employed to serve a single physical level device, which in this case might be an integrated weather station comprising all the sensors, detectors and meters shown as separate devices in FIG. 7. The preconfigured TDMA scheme for the communication between nodes and a controller module may be such that it dictates a fixed data speed per node, for example 80 bits/s if there are 200 nodes coupled to one controller module. This may be more than sufficient for certain types of physical level devices but simultaneously fail to meet the needs for some other types of physical level devices. Several “component” nodes may be integrated into a “supernode”, which has one connection to the twisted pair linking it to the controller module, and one connection to a physical level device, which connections however are distributed within the integrated supernode to several component nodes. The number of component nodes may be (even much) larger than two. In the TDMA scheme a supernode receives a communication capacity that is the number of component nodes times the capacity allocated to an ordinary node in the TDMA scheme. Taken the above-mentioned 80 bits/s per ordinary node as an example, integrating a dozen or more component nodes into a supernode allows allocating data speeds exceeding 1 kbit/s for certain physical level devices with little or no modifications to the other configuration of the remote monitoring and control system or to the TDMA scheme.

FIG. 8 illustrates schematically a controller module 231 that comprises an integrated PID (Proportional integral Derivative) controller 801. According to a well-known definition, a PID controller is a feedback controller whose output, commonly designated as the control variable, is based on the error between some predefined reference point and some measured process variable. The “P” control element of the PID controller acts on the basis of the error multiplied by a gain; the “I” control element on the basis of an integral of the error multiplied by a gain: and the “D” control element on the basis of a rate of change of the error multiplied by a gain. Not all of said gain values need to be different from zero; for example zeroing the gain associated with the “I” control element simply results in “PI” type control. Circuit-level implementations of PID controllers are widely available commercially, and implementing one as a part of node functionality is straightforward.

According to the principle illustrated in FIG. 8, the PID controller 801 receives the reference value(s) from a remote user or through an extension interface of the controller module 231 during on-site programming at system setup, and delivers some reports about how the controlling proceeds to the remote user. Measurement devices are typically coupled to so-called sensor nodes, so the process variable that describes the measured condition of the controlled process come from a sensor node. The control variable that comes as an output of the PID controller 801 goes to an actuator node, which is one controlling a physical device the operation of which has an effect on the process variable(s).

Nodes can communicate with each other through the shared connection arrangement that links them to the controller module, because every device that is connected to the connection arrangement can receive the transmissions of every other device, so in principle it would be possible to build a PID controller even to a node and use the controller module 231 only for conveying information between the PID controlled process and the remote user. However, it is more in line with the basic principles of the invention to keep the nodes as simple and inexpensive as possible, and realise programmable control functions higher up in device hierarchy, preferably in the controller module 231.

An advantageous practical implementation of the principle shown in FIG. 8 could involve using the internal temperature of a container housing the monitored electronic devices as a measured process variable, comparing it to a predefined reference temperature, and using the control variable output from the PID controller to drive a ventilation fan, thus aiming at keeping the internal temperature within prescribed limits. Many known ventilation arrangements of base station sites comprise even two fans, one for fresh air intake and another for blowing out used air. Both fans can be controlled in the PID controlling process.

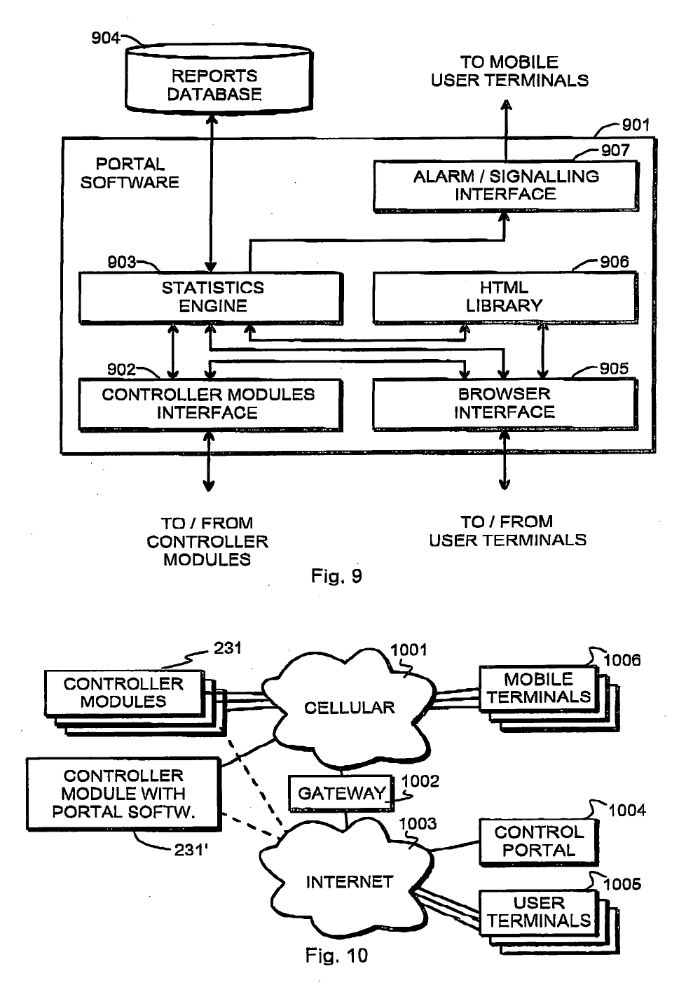

FIG. 9 illustrates the operation of an exemplary form of portal software 901 that can be used at a remote server, which from the viewpoint of a controller module is at the other end of the long-distance communications connection exemplified above as a GPRS connection. Connections to and from controller modules go logically through a controller modules interface 902, the task of which is to implement all communications protocols needed for communicating with the controller modules. A statistics engine 903 is adapted to receive reports from the controller modules, to store the reported information in a report database 904 and to process the report information. In order to offer an interface towards users there is a browser interface 905, which utilises HTML pages from an HTML library 906 to communicate with users. If an HTML page offered to a user requires the presentation of reported information in a particular form, like a graph of measured temperatures over the past week or a thumbnail table of ten most recent photographs taken by a surveillance camera, this information is requested from the statistics enging 903, which reads it from the report database 904 and processes it into the format required by said HTML page. A suitably authorized user may also give commands through the browser interface 905 to control the operation of the portal software 901 and therethrough the operation of the controller modules to which there are connections through the controller modules interface 902.

FIG. 9 also shows an alarms and signalling interface 907, which is adapted to send alarms and/or notifications to selected user terminals, which most appropriately are mobile terminals, if and when the portal software 901 receives from the controller modules reports concerning certain triggering events. Examples of triggering events might include, without being limited to, a detected break-in, an observation about a critical temperature having been reached, an observation concerning power failure and an indication about critical system malfunction. An alarm could be sent for example in the form of an SMS or MMS message.

FIG. 10 illustrates how various system components are located in respect of each other. The long-distance connections from the controller modules 231 go preferably through a cellular radio system 1001, a gateway apparatus 1002 and the internet 1003 to a control portal 1004, in which the portal software 901 of FIG. 9 is executed. The user terminals 1005 are also connected here to the internet 1003, although at least one user terminal typically has a more direct connection to the control portal 1004 through a local area network. The mobile terminals 1006 of users are connected to the cellular radio system 1001.

A controller module can also be programmed to execute at least a limited version of portal software of the kind illustrated schematically in FIG. 9. In FIG. 10 such a “mini-portal” type controller module appears as 231′. The limitedness of the portal software there typically means that the controller module in question is only responsible for receiving the reports of its own nodes as well as the nodes of a small number of other, related controller modules. The long distance connection to and from the controller modules 231 and 231′ does not necessarily go through a separate cellular radio system. It may also come directly to the internet 1003, which is shown with dashed line connections in FIG. 10.

1. An arrangement for facilitating remote monitoring and control of an independent target location, comprising:
physical level devices (106, 107, 108, 109, 110, 111, 112, 211) adapted to at least acquire information at the target location, p1 a transceiver (511) adapted to exchange information with a remote central system, and
between the physical level devices (106, 107, 108, 109, 110, 111, 112, 211) and the transceiver (511) a two-tier hierarchy of system elements, said two-tier hierarchy comprising a multitude of nodes (221) and at least one controller module (231, 231′), of which said nodes (221) are connected to said physical level devices (106, 107, 108, 109, 110, 111, 112, 211), and said controller module (231, 231′) is connected to said nodes (221) and to said transceiver (511); characterized in that it comprises
a polarity- and topology-independent cable connection (222) between said controller module (231, 231′) and said nodes (221),
in said controller module (231, 231′), means (503, 504, 505) for feeding an oscillating signal into said cable connection (222),
in each node (221), means (301) for using a first part of an oscillating signal received from said cable connection (222) as operating power for the node (221) and means (302, 303, 304, 305, 307) for using a second part of an oscillating signal received from said cable connection (222) as received data, and
in each node, means (312) for transmitting information by controllably changing an impedance of said cable connection (222).

2. An arrangement according to claim 1, characterized in that there is one to one correspondence between physical level devices (106, 107, 108, 109, 110, 111, 112, 211) and nodes (221), so that there is exactly one node (221) connected to each physical level device (106, 107, 108, 109, 110, 111, 112, 211).

3. An arrangement according to claim 1, characterized in that said cable connection (222) is a twisted pair (401), to which said nodes (221) are connected in parallel, and said means (312) in each node (221) for transmitting information comprise a switch (312) for short circuiting said twisted pair (401) through a resistance.

4. An arrangement according to claim 1, characterized in that it is adapted to apply time division multiple access within said cable connection (222), so that said controller module (231, 231′) is adapted to transmit information to a particular node (221) in an allocated time interval.

5. An arrangement according to claim 1, characterized in that it comprises a combination of a toggle relay (411) and a load (412) connected thereto as a physical level device, wherein a node (221) connected to said toggle relay (411) is adapted to control a conductive state of said toggle relay (411).

6. An arrangement according to claim 1, characterized in that it comprises a switch (421) as a physical level device, wherein a node (221) connected to said switch (421) is adapted to acquire information about a conductive state of said switch (421).

7. An arrangement according to claim 1, characterized in that it comprises a combination of a triac driver (431) and a load (432) connected thereto as a physical device, wherein a node (221) connected to said triac driver (431) is adapted to act as a phase angle controller of the operation of said load (432).

8. An arrangement according to claim 1, characterized in that it comprises a combination of a switch (442) and a load (443) connected thereto as a physical device, wherein a node (221) coupled to said switch (442) is adapted to act as a pulse width modulation controller of the operation of said load (443).

9. An arrangement according to claim 1, characterized in that it comprises a measurement head (451), adapted to produce an analog voltage signal as a measured value, as a physical device, wherein a node (221) connected to said measurement head (451) is adapted to convert said analog voltage signal into a digital signal and to transmit said digital signal to at least one of said controller module (431) or another node (221).

10. An arrangement according to claim 1, characterized in that it comprises a digitally controlled device (461, 462) as a physical level device, wherein a node (221) connected to said digitally controlled device (461, 462) is adapted to receive a digital signal from at least one of said controller module (431) or another node (221) and to output a digital signal as a control signal to said digitally controlled device (461, 462).

11. An arrangement according to claim 1, characterized in that it comprises a PID controller (801) in a controller module, which PID controller (801) is adapted to receive a reference value, to receive a value of a process variable from a first node, and to deliver a control variable to a second node.

12. An arrangement according to claim 1, characterized in that in order to enable allocating a higher than average date speed between a certain physical level device and a certain controller module it comprises a supernode that includes a number of component nodes that are all coupled to the same physical level device.

13. An arrangement according to claim 1, characterized in that said independent target location is a base station site of a cellular radio system, and the arrangement comprises weather monitoring instruments (701, 702, 703, 704, 705, 706) as physical level devices.

14. An arrangement according to claim 1, characterized in that said controller module (231′) is adapted to execute portal software (901) comprising a browser interface (905) for remote users, said portal software (901) being adapted to collect and process information received from nodes operating in connection with said controller module (231′).
